(19) United States
(12) Patent Application Publication
(10) Pub. No.: US 2023/0401382 A1
(43) Pub. Date: Dec. 14, 2023

(54) Dynamic Language Models for Continuously Evolving Content

(71) Applicant: Google LLC, Mountain View, CA (US)

(72) Inventors: Spurthi Amba Hombaiah, Mountain View, CA (US); Mingyang Zhang, San Jose, CA (US); Michael Bendersky, Cupertino, CA (US); Tao Chen, Sunnyvale, CA (US); Marc Alexander Najork, Palo Alto, CA (US)

(21) Appl. No.: 18/249,275

(22) PCT Filed: Oct. 19, 2021
(86) PCT No.: PCT/US2021/055578

§ 371 Date: Apr. 17, 2023

Related U.S. Application Data
(60) Provisional application No. 63/093,524, filed on Oct. 19, 2020.

(51) Int. Cl. G06F 40/242; G06F 40/40; G06F 40/30; G06F 40/284

(52) U.S. Cl. CPC G06F 40/242; G06F 40/40; G06F 40/30; G06F 40/284

(57) ABSTRACT

Provided are systems and methods for incremental training of machine learning models to adapt to changes in an underlying data distribution. One example setting in which the techniques described herein may be beneficial is for incrementally training natural language models to enable the models to have or adapt to a dynamically changing vocabulary. Incremental training is provided as a feasible and inexpensive way of adapting machine learning models to evolving vocabulary without having to retrain them from scratch.

### RELATED APPLICATIONS

This application claims priority to and the benefit of U.S. Provisional Patent Application No. 63/093,524, filed Oct. 19, 2020. U.S. Provisional Patent Application No. 63/093,524 is hereby incorporated by reference in its entirety.

### FIELD

The present disclosure relates generally to machine learning such as, for example, machine learning for natural language modeling. More particularly, the present disclosure relates to incremental machine learning in the batch and/or online settings, such as, for example, incremental learning to enable a language model to have a dynamic vocabulary.

### BACKGROUND

Machine learning techniques often attempt to learn a model that approximates or otherwise makes predictions relative to an underlying data distribution. However, in many real-world scenarios, the underlying data distribution changes over time.

As one example, machine learning models for natural language may attempt to model semantic meaning, interrelatedness, contextual usage, etc. of a natural language (e.g., as represented by a vocabulary of tokens such as phonemes, n-grams, and/or words). However, natural languages change over time, including word additions (e.g., new acronyms, portmanteaus and neologisms), word obsolescence, and/or the semantic drift of words. This phenomenon is particularly evident in text used on the World Wide Web (e.g., in news articles, web sites, social media, etc.) which changes quickly due to fluctuations in cultural usage and current events.

As a result of this shift in the underlying distribution, a machine learned model trained on historical data is not able to achieve the same performance on data in future epochs in which the underlying data distribution has changed. Therefore, to maintain consistent performance on the downstream tasks over time, the corresponding machine learning models need to be updated to reflect the changing data.

Currently, most applications which leverage machine learning address this issue by training their models from scratch when they notice that their models have degraded performance (i.e., training an entirely new model on new training data). However, this is a computationally expensive way to address the problem as it uses a large amount of compute and data to achieve the desired performance on newer data (i.e., to train an entirely new model from scratch).

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for performing machine learning. The method includes obtaining, by a computing system comprising one or more computing devices, a first version of a machine-learned model that has a plurality of first learned embeddings respectively for a plurality of entities. The method includes re-training, by the computing system, the first version of the machine-learned model to obtain a second version of the machine-learned model that has a plurality of second learned embeddings respectively for the plurality of entities. The method includes determining, by the computing system, for each entity, a respective similarity score between the first learned embedding for the entity and the second learned embedding for the entity. The method includes identifying, by the computing system, a subset of the entities that have respective similarity scores that indicate relative dissimilarity between their respective embeddings. The method includes selecting, by the computing system and based at least in part on the identified subset of entities, training examples for inclusion in a training dataset, such that the training dataset is biased toward training examples that include one or more of the identified subset of entities. The method includes re-training, by the computing system, the second version of the machine-learned model with the training dataset to obtain a third version of the machine-learned model having a plurality of third learned embeddings for the plurality of entities.

Another example aspect of the present disclosure is directed to one or more non-transitory computer-readable media that collectively store instructions that, when executed by one or more processors cause the one or more processors to perform operations. The operations include obtaining a first version of a machine-learned model. The operations include re-training the first version of the machine-learned model to obtain a second version of the machine-learned model. The operations include processing a plurality of training examples with the first version of the machine-learned model to respectively obtain a plurality of first embeddings generated by the first version of the machine-learned model respectively for the plurality of training examples. The operations include processing the plurality of training examples with the second version of the machine-learned model to respectively obtain a plurality of second embeddings generated by the second version of the machine-learned model respectively for the plurality of training examples. The operations include determining, for each of the plurality of training examples, a respective similarity score between the first embedding generated for the training example by the first version of the machine-learned model and the second embedding generated for the training example by the second version of the machine-learned model. The operations include selecting, based at least in part on the similarity scores, training examples for inclusion in a training dataset, such that the training dataset is biased toward training examples that have respective similarity scores that indicate relative dissimilarity between their respective embeddings. The operations include re-training the second version of the machine-learned model with the training dataset to obtain a third version of the machine-learned model.

Another example aspect of the present disclosure is directed to a computing system configured to perform online hard example mining for an actively deployed machine-learned model. The computing system includes one or more processors and one or more non-transitory computer-readable media that collectively store instructions that, when executed by one or more processors, cause the computing system to perform operations. The operations include deploying a machine-learned model to perform a task. The operations include performing online learning to re-train the machine-learned model with online training examples while the machine-learned model is deployed to perform the task. The operations include maintaining, as part of performing online learning, a log of respective loss values exhibited by the machine-learned model for the online training examples as evaluated by a loss function. The operations include identifying a subset of the online training examples as hard examples based at least in part on the respective loss values exhibited by the machine-learned model for the online training examples. The operations include re-training the machine-learned model using the identified subset of online training examples that are hard examples.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

The attached Appendix, which is incorporated into and forms a portion of this disclosure, describes example embodiments of the systems and methods of the present disclosure. The systems and methods of the present disclosure are not limited to the example embodiments described in the attached Appendix.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a flow chart diagram of an example method to enable a machine-learned model to have a dynamic vocabulary according to example embodiments of the present disclosure.

FIG. 2 depicts a flow chart diagram of an example method to perform machine learning with training example selection based on changes in entity embeddings according to example embodiments of the present disclosure.

FIG. 3 depicts a flow chart diagram of an example method to perform machine learning with training example selection based on changes in training example embeddings according to example embodiments of the present disclosure.

FIG. 4 depicts a flow chart diagram of an example method to perform online learning according to example embodiments of the present disclosure.

FIG. 5A depicts a block diagram of an example computing system according to example embodiments of the present disclosure.

FIG. 5B depicts a block diagram of an example computing device according to example embodiments of the present disclosure.

FIG. 5C depicts a block diagram of an example computing device according to example embodiments of the present disclosure.

Reference numerals that are repeated across plural figures are intended to identify the same features in various implementations.

### DETAILED DESCRIPTION

### Overview

Example aspects of the present disclosure are directed to systems and methods for incremental training of machine learning models to adapt to changes in an underlying data distribution. One example setting in which the techniques described herein may be beneficial is for incrementally training natural language models to enable the models to have or adapt to a dynamically changing vocabulary. In particular, the vocabulary of text used on the Web keeps evolving incrementally. There are word additions, word obsolescence and semantic drift of words over time. Aspects of the present disclosure provide techniques which enable machine learning models to be evolved incrementally to such changing data to achieve good performance on one or more of various downstream tasks. This incremental re-training of models is in contrast to certain alternative approaches that completely re-train the model from scratch on newly collected training data, incurring significant computational costs. Instead, example implementations of the present disclosure propose incremental training as a feasible and inexpensive way of adapting machine learning models to evolving vocabulary without having to retrain them from scratch. However, while the systems and methods of the present disclosure provide benefits in natural language modeling cases, the proposed techniques are equally applicable to other domains of machine learning tasks, including various image processing tasks such as image classification, object detection, object recognition, etc. In such image processing embodiments, the “vocabulary” of entities may, for example, be a set of image classification categories, a set of object classes for objects in the image or an image dataset, a set of object shapes for objects in the image or an image dataset, or the like.

One example aspect of the present disclosure provides techniques to evolve or update a “vocabulary” of entities handled by a machine learning model over time. For example, the entities can be items, locations, users, and/or natural language tokens. In particular, at each of a number of epochs or time slices, new entities (e.g., language tokens of a natural language, object and/or image classes for image classification) which occur in high frequencies in the current time slice can be added to the vocabulary while entities which appear in low frequencies can be removed, thus keeping the vocabulary size fixed while adapting to changes in entity usage, frequency, or relevance. Example tokens include phonemes, n-grams, words, subword segments, hashtags, and/or other forms of tokens.

Another example aspect of the present disclosure is directed to techniques to identify entities for which a change in semantic meaning or other shift in usage or definition has occurred. In particular, certain model types (e.g., language models, recommendation models, etc.) may directly model and/or store a respective entity embedding for each entity included in the vocabulary. As such, for two versions of a machine learning model (e.g., an earlier version and a more-recently-trained version), the respective entity embeddings stored by each of the two versions of the model for the same entity can be compared. If the embeddings for a given entity are significantly different from one another, this may indicate a change in semantic meaning or other shift in usage or definition of the entity has occurred.

To provide an example, token embeddings comparison can be performed for two versions of a natural language model. In particular, example implementations of the present disclosure can compare the token embeddings stored by a current version of the model with the token embeddings stored by previous version(s) of the model and identify the top-k % of tokens with the lowest cosine similarities between their respective embeddings. The identified tokens (e.g., words) and, optionally, one or more new tokens added to the vocabulary can be used to draw a weighted random sample of training examples for further incremental training.

Another example aspect of the present disclosure is directed to techniques to intelligently sample from available training examples to make training converge faster and also to use fewer examples to achieve the same level of performance on changing data. For example, each of a number of training examples can be provided to two versions of a machine learning model (e.g., an earlier version and a more-recently-trained version). Each version of the model can generate a respective embedding for the training example. If the respective embeddings are significantly different, the training example can be selected for inclusion in a training dataset which is used to further train the machine learning model. Thus, example aspects of the present disclosure provide active learning based approaches which can be used to identify hard examples to train the model with to make the convergence faster.

To provide an example, a training example embeddings comparison can be performed for two versions of a model (e.g., a natural language model). In particular, example implementations of the present disclosure can compare the respective embedding generated for a training example (e.g., a natural language sentence, an image) by a current version of the model with the embedding generated by previous version(s) of the model. For example, a cosine similarity can be computed. The evaluated similarity metrics can be used to draw a weighted random sample of training examples for further incremental training.

The proposed solutions can be used in both online and batch learning settings. In particular, in the batch setting, the present disclosure provides methods to identify training examples which contain new words (or categories/classifications) and words (or categories/classifications) which would have semantically shifted.

In the online setting, the proposed systems and methods can identify hard examples as and when the examples/data are processed by an online model. Specifically, example implementations of the present disclosure can monitor the loss of the online examples. As examples, the monitored loss can be a task-specific loss or can be a pre-training loss that provides an evaluation that is different from the specific task the model is deployed to perform. In some implementations the pre-training loss can be a generic loss (e.g., as opposed to a task-specific loss).

In some implementations, the pre-training loss can be an unsupervised loss such as, for example, a mask language modeling loss. In some implementations, once the top-k % of examples with the largest losses are accumulated, the computing system can trigger incremental training. Alternatively or additionally, when model performance (e.g., as evaluated by the loss such as the pre-training loss) falls below some threshold, the incremental training can be triggered. This online setup helps in adapting the model faster to evolving data at a small cost of inference of the examples on unsupervised tasks.

The systems and methods provide a number of technical advantages over existing approaches. As one example technical effect, the proposed techniques can incrementally evolve the model to achieve good performance on new data with the idea of incremental training, thus limiting the compute resources and training time. Specifically, incremental training can include re-training a deployed model on small amounts of new data, where the model is initialized at the deployed checkpoint for the re-training process. This avoids needing to perform the computationally expensive process of training an entirely new model from scratch.

As another example technical effect, the present disclosure provides solutions to identify hard examples to make the model converge faster during training for both online and batch settings. This provides significant benefits when there is only limited data available for use in training. The proposed approaches also further limit the training time and compute resources for adapting the model, thereby reducing usage of computational resources such as processor usage, memory usage, network bandwidth, etc.

The proposed systems and methods can be used in any domain/application where there is a constant change in data and vocabulary. As one example, the proposed techniques would be useful for any time-sensitive applications like News recommendation, topic prediction, sentiment analysis, natural language generation, subject/topic prediction (e.g., in the form of hashtags) for social media content, and/or various other natural language tasks. In particular, if a language model evolves very quickly for new events, especially if the new events are associated with some new words, then the proposed technologies can provide significant benefit.

With reference now to the Figures, example embodiments of the present disclosure will be discussed in further detail.

### Example Methods

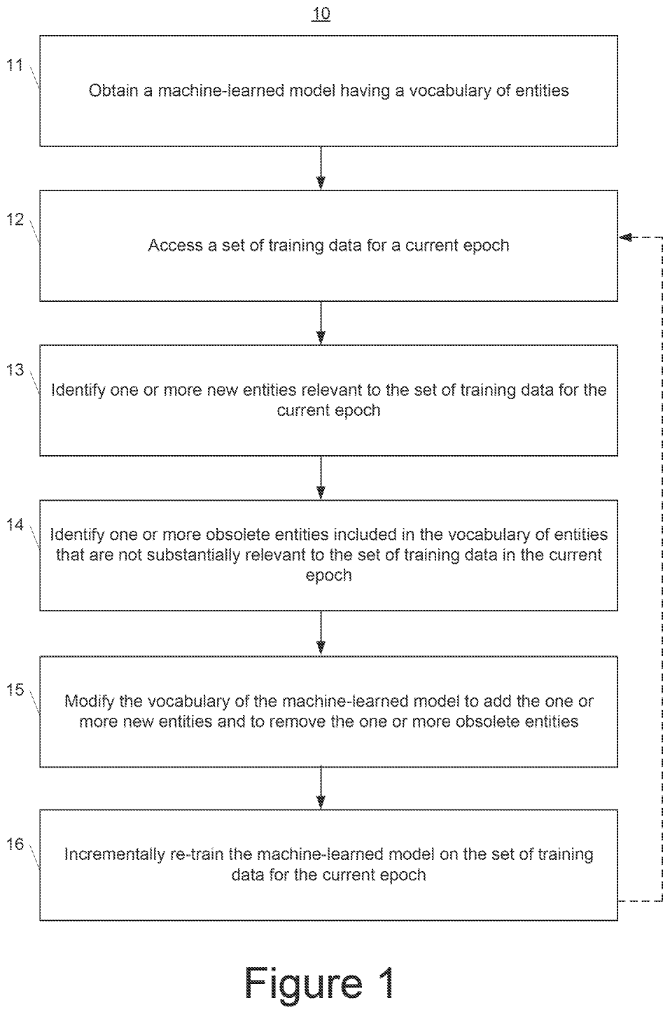

FIGS. 1-4 depict flow chart diagrams of example methods according to example embodiments of the present disclosure. Although each of FIGS. 1-4 depicts steps performed in a particular order for purposes of illustration and discussion, the methods of the present disclosure are not limited to the particularly illustrated order or arrangement. The various steps of each of the illustrated methods can be omitted, rearranged, combined, and/or adapted in various ways without deviating from the scope of the present disclosure.

FIG. 1 depicts a flow chart diagram of an example method 10 to enable a machine-learned model to have a dynamic vocabulary according to example embodiments of the present disclosure.

At 11, a computing system can obtain a machine-learned model having a vocabulary of entities. For example, the entities can be items, locations, users, and/or natural language tokens. For example, the machine-learned model can store a respective learned embedding for each entity. The machine-learned model can have been previously pre-trained, trained, and/or re-trained on various sets of training data using pre-training loss functions and/or task-specific loss functions.

At 12, the computing system can access a set of training data for a current epoch. For example, the training data can be data that was collected during a most recent period of time (e.g., such as textual content or images used on the World Wide Web within a most recent period of time such as a week, month, quarter, year, etc.).

At 13, the computing system can identify one or more new entities relevant to the set of training data for the current epoch. For example, the new entities can be entities that are not included in the current vocabulary but which are represented or included with greater than some threshold frequency or amount in the set of the training data for the current epoch. Thus, entities that are newly used or being used with increased frequency can be identified.

At 14, the computing system can identify one or more obsolete entities that are included in the vocabulary of entities but that are not substantially relevant to the set of training data in the current epoch. For example, the obsolete entities can be entities that are included in the current vocabulary but which are represented or included with less than some threshold frequency or amount in the set of the training data for the current epoch. Thus, entities that are no longer used or being used with reduced frequency can be identified.

At 15, the computing system can modify the vocabulary of the machine-learned model to add the one or more new entities and to remove the one or more obsolete entities, thereby updating the vocabulary for the model. In some implementations, the number of new entities added can equal the number of obsolete entities removed. This can enable the vocabulary to stay the same size, which can have benefits such as obviating the need to add or reduce parameters to the machine-learned model. In other implementations, the size of the vocabulary can change over time.

At 16, the computing system can incrementally re-train the machine-learned model on the set of training data for the current epoch. Specifically, incremental training can include re-training the machine-learned model on only the new training data with the model initialized at the most-recent checkpoint.

After 16, method 10 can optionally return to 12. In such fashion, a vocabulary of the model can be dynamically updated over time to account for changes in the usage of entities in training data over iterative epochs.

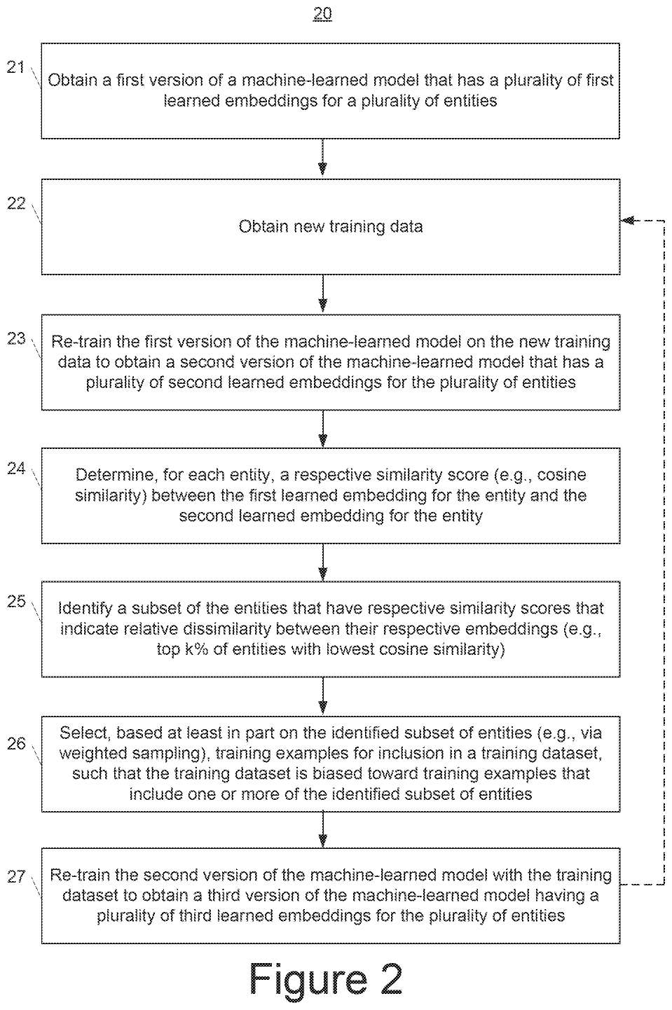

FIG. 2 depicts a flow chart diagram of an example method 20 to perform machine learning with training example selection based on changes in entity embeddings according to example embodiments of the present disclosure.

At 21, a computing system can obtain a first version of a machine-learned model that has a plurality of first learned embeddings for a plurality of entities. For example, the entities can be items, locations, users, and/or natural language tokens. For example, the machine-learned model can store a respective learned embedding for each entity. The machine-learned model can have been previously pre-trained, trained, and/or re-trained on various sets of training data using pre-training loss functions and/or task-specific loss functions. In some examples, the machine-learned model can be or include a language model (e.g., a doze language model) and the plurality of entities can be or include a plurality of tokens included in a vocabulary. In other examples, the plurality of entities can be or include a plurality of candidate items available for recommendation, a plurality of users to provide recommendations to, or both.

At 22, the computing system can obtain new training data. For example, the new training data can be batch training data or can be online training data. For example, the training data can be data that was collected during a most recent period of time (e.g., such as textual or visual content used on the World Wide Web within a most recent period of time such as a week, month, quarter, year, etc.).

At 23, the computing system can incrementally re-train the first version of the machine-learned model on the new training data to obtain a second version of the machine-learned model that has a plurality of second learned embeddings for the plurality of entities.

At 24, the computing system can determine, for each entity, a respective similarity score between the first learned embedding for the entity and the second learned embedding for the entity. For example, the respective similarity score between the first learned embedding for the entity and the second learned embedding can be or include a cosine similarity between the first learned embedding for the entity and the second learned embedding.

At 25, the computing system can identify a subset of the entities that have respective similarity scores that indicate relative dissimilarity between their respective embeddings. For example, dissimilarity between the embeddings can indicate that the entity has experienced a semantic shift or other change in meaning or usage. For example, the computing system can identify the top k % of entities with lowest cosine similarity, where k is real-valued. Alternatively, any entity with a cosine similarity below a threshold can be identified.

At 26, the computing system can select, based at least in part on the subset of entities identified at 25, training examples for inclusion in a training dataset, such that the training dataset is biased toward training examples that include one or more of the identified subset of entities. For example, the computing system can perform weighted sampling of training examples where training examples that include one or more of the identified subset of entities are sampled with increased weight.

At 27, the computing system can incrementally re-train the second version of the machine-learned model with the training dataset selected at 26 to obtain a third version of the machine-learned model having a plurality of third learned embeddings for the plurality of entities. Alternatively, the first version of the machine-learned model can be re-trained to generate the third version of the model.

After 27, method 20 can optionally return to 22. For example, the third version of the model can be treated as the “first” version of the model at the next instance of block 23.

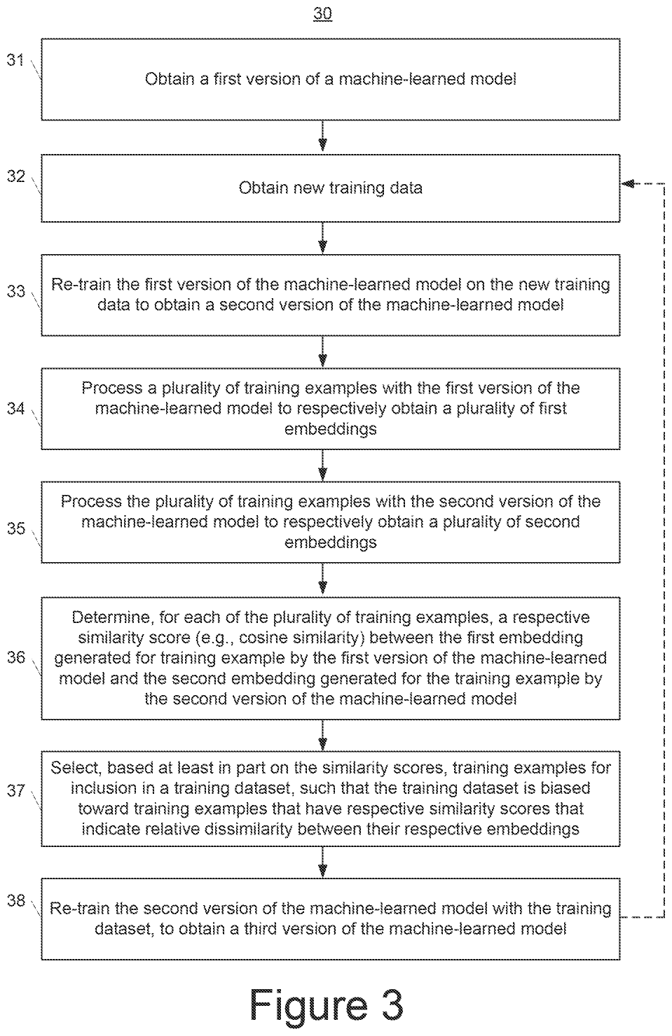

FIG. 3 depicts a flow chart diagram of an example method 30 to perform machine learning with training example selection based on changes in training example embeddings according to example embodiments of the present disclosure.

At 31, a computing system can obtain a first version of a machine-learned model. The machine-learned model can have been previously pre-trained, trained, and/or re-trained on various sets of training data using pre-training loss functions and/or task-specific loss functions. In some implementations, the machine-learned model can be a language model (e.g., a doze language model). In some implementations, the machine-learned model can be an embedding or encoder model such as an image embedding model.

At 32, the computing system can obtain new training data. For example, the new training data can be batch training data or can be online training data. For example, the training data can be data that was collected during a most recent period of time (e.g., such as textual content used on the World Wide Web within a most recent period of time such as a week, month, quarter, year, etc.).

At 33, the computing system can incrementally re-train the first version of the machine-learned model on the new training data to obtain a second version of the machine-learned model.

At 34, the computing system can process a plurality of training examples (e.g., from the new training data obtained at 32) with the first version of the machine-learned model to respectively obtain a plurality of first embeddings for the training examples. In some implementations, each training example can contain one natural language sentence.

At 35, the computing system can process the plurality of training examples (e.g., from the new training data obtained at 32) with the second version of the machine-learned model to respectively obtain a plurality of second embeddings for the training examples.

At 36, the computing system can determine, for each of the plurality of training examples, a respective similarity score between the first embedding generated for the training example by the first version of the machine-learned model and the second embedding generated for the training example by the second version of the machine-learned model. For example, the respective similarity score between the first embedding for the training example and the second embedding for the training example can be or include a cosine similarity between the first embedding and the second embedding.

At 37, the computing system can select, based at least in part on the similarity scores, training examples for inclusion in a training dataset, such that the training dataset is biased toward training examples that have respective similarity scores that indicate relative dissimilarity between their respective embeddings. For example, dissimilarity between the embeddings can indicate that the content of the training example has experienced a semantic shift or other change in meaning or usage. For example, the computing system can identify the top k % of training examples with lowest cosine similarity, where k is real-valued. Alternatively, any training examples with a cosine similarity below a threshold can be identified. In some implementations, the computing system can perform a weighted sampling of the training examples, where a respective weight associated with each training example is based at least in part on the similarity score for the training example.

At 38, the computing system can incrementally re-train the second version of the machine-learned model with the training dataset selected at 37 to obtain a third version of the machine-learned model.

After 38, method 30 can optionally return to 32. For example, the third version of the model can be treated as the “first” version of the model at the next instance of block 33.

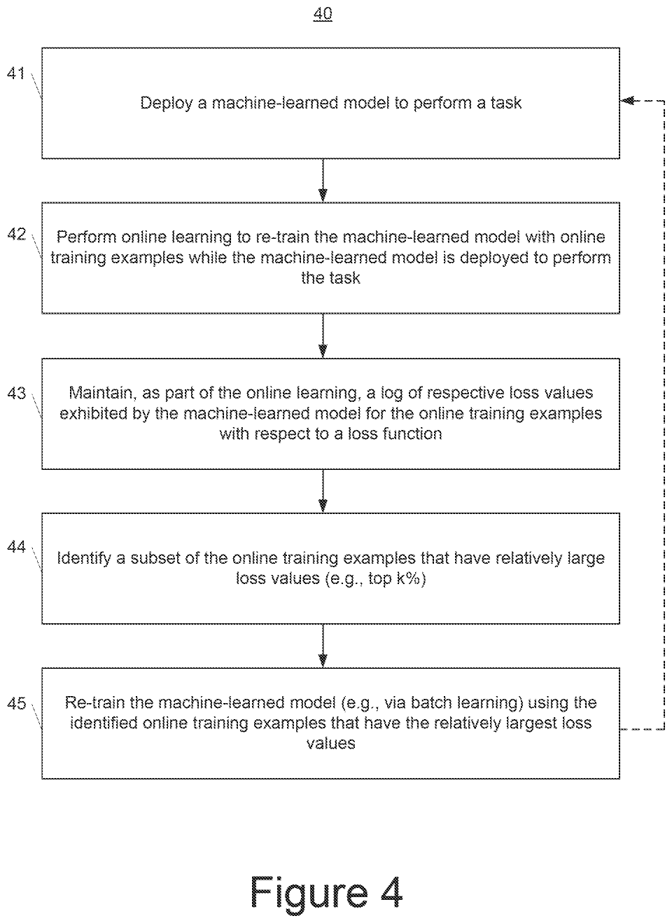

FIG. 4 depicts a flow chart diagram of an example method 40 to perform online learning according to example embodiments of the present disclosure.

At 41, a computing system can deploy a machine-learned model to perform a task. The machine-learned model can have been previously pre-trained, trained, and/or re-trained on various sets of training data using pre-training loss functions and/or task-specific loss functions.

At 42, the computing system can perform online learning to re-train the machine-learned model with online training examples while the machine-learned model is deployed to perform the task. The re-training can be done, for example, using pre-training loss functions and/or task-specific loss functions.

At 43, the computing system can maintain, as a part on the online learning performed at 42, a log of respective loss values exhibited by the machine-learned model for the online training examples with respect to a loss function. The loss function used at 43 can be the same as or different from the loss function used to perform online learning at 42. The loss function at 43 can be a task specific loss function or a pre-training loss function. The loss function at 43 can be an unsupervised or weakly supervised loss function.

In one example, the machine-learned model is a language model and a pre-training loss function used at 43 is or includes a masked language modeling loss function. In another example, the loss function used at 43 is or includes a click-through-rate loss function that evaluates a click-through-rate of content selected by the machine-learned model.

At 44, the computing system can identify a subset of the online training examples that have relatively large loss values. These examples can be referred to as hard training examples. For example, the computing system can identify the top k % of training examples with largest loss values, where k is real-valued. Alternatively, any training examples with a loss value above a threshold can be identified.

In one example, performance of block 44 is triggered upon detection of a re-training condition. As an example, in some implementations, once the top-k % of examples with the largest losses are accumulated, the computing system can trigger incremental training (e.g., performance of blocks 44 and 45). Alternatively or additionally, when model performance (e.g., as evaluated by the loss function such as a pre-training loss) falls below some threshold, the incremental training can be triggered.

At 45, the computing system can re-train the machine-learned model (e.g., via batch learning) using the identified online training examples that have the relatively largest loss values. More particularly, in some implementations, the examples with the largest losses identified at 44 are not directly used, but instead the examples chosen to do further training at 45 are biased towards those with largest losses (e.g., weighted random sample). Thus, re-training can be performed using a subset of online examples biased towards those with the largest loss values.

After 45, method 40 can optionally return to 41 and, for example, deploy the re-trained model to perform the task.

### Example Devices and Systems

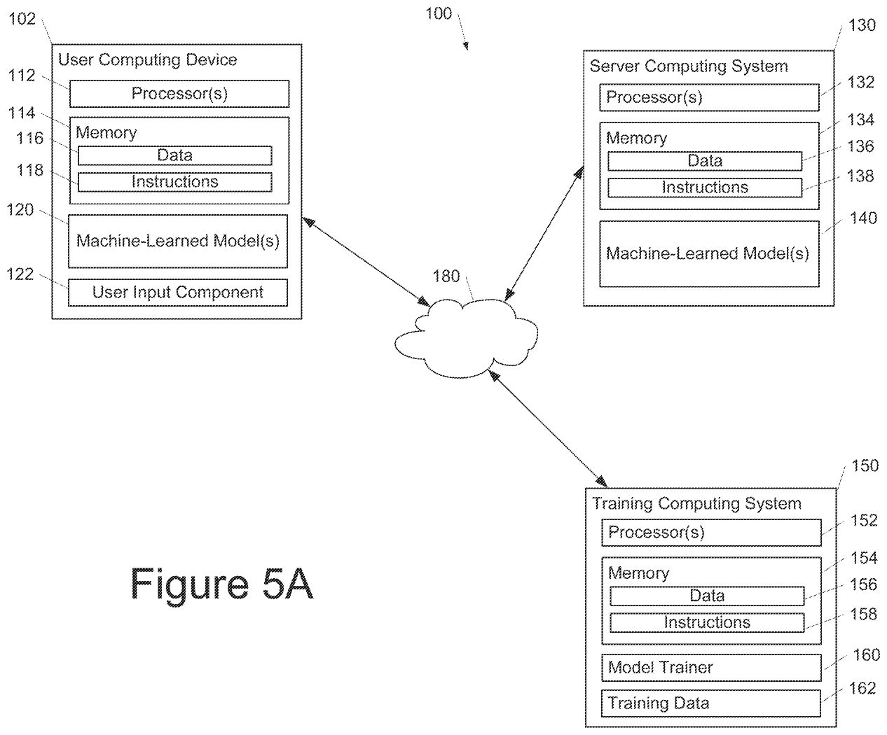

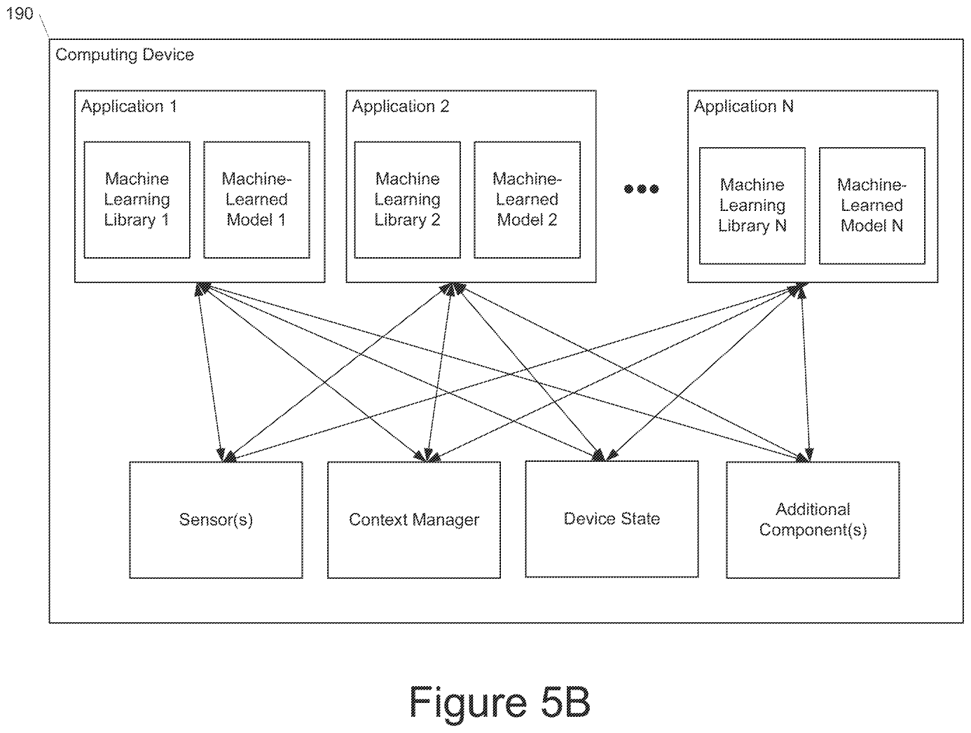

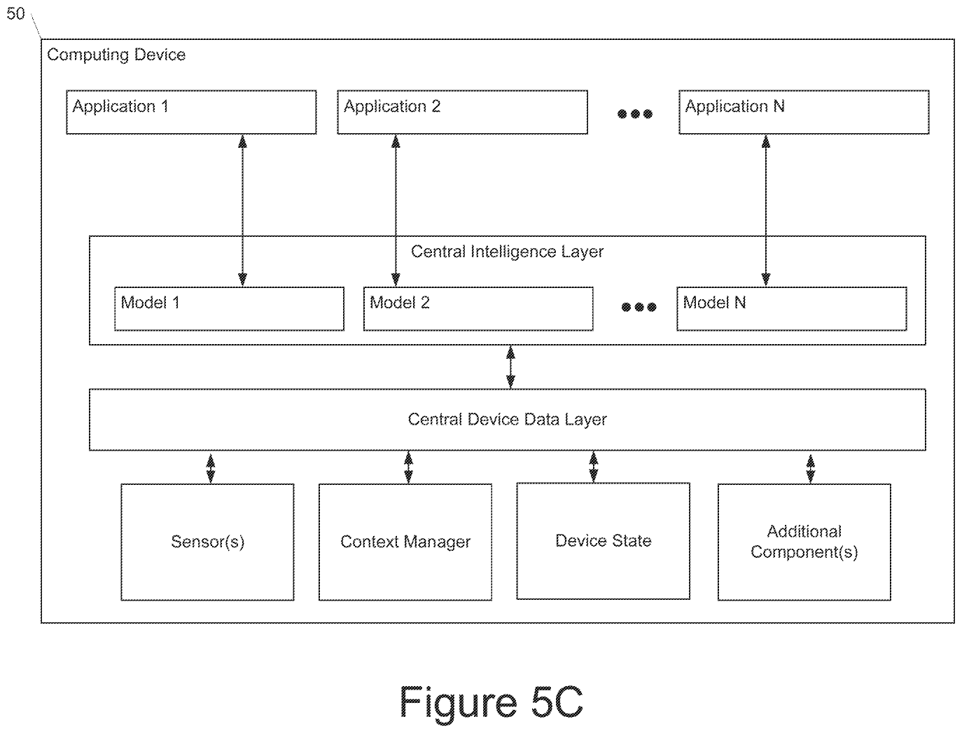

FIG. 5A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks such as transformer or other self-attention-based networks.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel natural language tasks across multiple instances of language inputs).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, convolutional neural networks, and/or transformer or other self-attention-based networks.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, natural language data such as, for example, news articles, social media content, communication data, speech data, and/or other forms of language data.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 5A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 5B depicts a block diagram of an example computing device 190 that performs according to example embodiments of the present disclosure. The computing device 190 can be a user computing device or a server computing device.

The computing device 190 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 5B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 5C depicts a block diagram of an example computing device 50 that performs according to example embodiments of the present disclosure. The computing device can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 5C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 5C, the central device data layer can communicate with a number of other components of the computing device, such as, for example, one or more sensors, a context manager, a device state component, and/or additional components. In some implementations, the central device data layer can communicate with each device component using an API (e.g., a private API).

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method for performing machine learning, the method comprising:
obtaining, by a computing system comprising one or more computing devices, a first version of a machine-learned model that has a plurality of first learned embeddings respectively for a plurality of entities;
re-training, by the computing system, the first version of the machine-learned model to obtain a second version of the machine-learned model that has a plurality of second learned embeddings respectively for the plurality of entities;
determining, by the computing system, for each entity, a respective similarity score between the first learned embedding for the entity and the second learned embedding for the entity;
identifying, by the computing system, a subset of the entities that have respective similarity scores that indicate relative dissimilarity between their respective embeddings;
selecting, by the computing system and based at least in part on the identified subset of entities, training examples for inclusion in a training dataset, such that the training dataset is biased toward training examples that include one or more of the identified subset of entities; and
re-training, by the computing system, the second version of the machine-learned model with the training dataset to obtain a third version of the machine-learned model having a plurality of third learned embeddings for the plurality of entities.

2. The computer-implemented method of claim 1, wherein:
the respective similarity score between the first learned embedding for the entity and the second learned embedding comprises a cosine similarity between the first learned embedding for the entity and the second learned embedding; and
identifying, by the computing system, a subset of the entities that have respective similarity scores that indicate relative dissimilarity between their respective embeddings comprises identifying a percentage of the entities that have the lowest cosine similarities or identifying entities that have a cosine similarity less than a threshold value.

3. The computing system of claim 1, wherein selecting, by the computing system and based at least in part on the identified subset of entities, training examples for inclusion in the training dataset comprises performing, by the computing system, a weighted sampling of candidate training examples, wherein a respective weight associated with each candidate training example is based at least in part on whether the candidate training example includes one or more of the identified subset of entities.

4. The computer-implemented method of claim 1, wherein:
re-training, by the computing system, the first version of the machine-learned model to obtain the second version of the machine-learned model comprises performing, by the computing system, online learning to re-train the first version of the machine-learned model with online training examples while the first version of the machine-learned model is deployed to perform a task; and
the training examples comprise the online training examples.

5. The computer-implemented method of claim 1, wherein the machine-learned model comprises a language model and wherein the plurality of entities comprise a plurality of tokens included in a vocabulary.

6. The computer-implemented method of fief claim 1, wherein the machine-learned model comprises a recommendation model and wherein the plurality of entities comprise a plurality of candidate items available for recommendation, a plurality of users to provide recommendations to, or both.

7. The method of claim 1, wherein the machine learned model is an image classification model that takes as input an image and outputs a distribution over one or more image and/or classes, and wherein the plurality of entities comprise the plurality of image and/or object classes.

8. One or more non-transitory computer-readable media that collectively store instructions that, when executed by one or more processors cause the one or more processors to perform operations, the operations comprising:
obtaining a first version of a machine-learned model;
re-training the first version of the machine-learned model to obtain a second version of the machine-learned model;
processing a plurality of training examples with the first version of the machine-learned model to respectively obtain a plurality of first embeddings generated by the first version of the machine-learned model respectively for the plurality of training examples;
processing the plurality of training examples with the second version of the machine-learned model to respectively obtain a plurality of second embeddings generated by the second version of the machine-learned model respectively for the plurality of training examples;
determining, for each of the plurality of training examples, a respective similarity score between the first embedding generated for the training example by the first version of the machine-learned model and the second embedding generated for the training example by the second version of the machine-learned model;
selecting, based at least in part on the similarity scores, training examples for inclusion in a training dataset, such that the training dataset is biased toward training examples that have respective similarity scores that indicate relative dissimilarity between their respective embeddings;
re-training the second version of the machine-learned model with the training dataset to obtain a third version of the machine-learned model.

9. The one or more non-transitory computer-readable media of claim 8, wherein:
the respective similarity score between the first embedding for the training example and the second embedding for the training example comprises a cosine similarity between the first embedding and the second embedding.

10. The one or more non-transitory computer-readable media of claim 8, wherein selecting, by the computing system and based at least in part on the similarity scores, training examples for inclusion in the training dataset comprises performing, by the computing system, a weighted sampling of the training examples, wherein a respective weight associated with each training example is based at least in part on the similarity score for the training example.

11. The one or more non-transitory computer-readable media of claim 8, wherein:
re-training, by the computing system, the first version of the machine-learned model to obtain the second version of the machine-learned model comprises performing, by the computing system, online learning to re-train the first version of the machine-learned model with online training examples while the first version of the machine-learned model is deployed to perform a task; and
the training examples comprise the online training examples.

12. The one or more non-transitory computer-readable media of claim 8, wherein re-training, by the computing system, the first version of the machine-learned model to obtain the second version of the machine-learned model comprises re-training the first version of the machine-learned model using the plurality of training examples.

13. The one or more non-transitory computer-readable media of claim 8, wherein the machine-learned model comprises a language model.

14. The one or more non-transitory computer-readable media of claim 13, wherein:
processing the plurality of training examples with the first version of the machine-learned model to respectively obtain the plurality of first embeddings comprises processing a plurality of sentences with the first version of the machine-learned model to respectively obtain the plurality of first embeddings for the plurality of sentences;
processing the plurality of training examples with the second version of the machine-learned model to respectively obtain the plurality of second embeddings comprises processing the plurality of sentences with the second version of the machine-learned model to respectively obtain the plurality of second embeddings for the plurality of sentences;
determining, for each of the plurality of training examples, the respective similarity score comprises determining, for each of the plurality of sentences, the respective similarity score; and
selecting the training examples for inclusion in the training dataset comprises selecting the training examples such that the training dataset is biased toward training examples that include sentences that have respective similarity scores that indicate relative dissimilarity between their respective embeddings.

15. The one or more non-transitory computer-readable media of claim 8, wherein the machine-learned model comprises an image embedding model.

16. A computing system configured to perform online hard example mining for an actively deployed machine-learned model, the computing system comprising:
one or more processors; and
one or more non-transitory computer-readable media that collectively store instructions that, when executed by one or more processors, cause the computing system to perform operations, the operations comprising:
deploying a machine-learned model to perform a task;
performing online learning to re-train the machine-learned model with online training examples while the machine-learned model is deployed to perform the task;
maintaining, as part of performing online learning, a log of respective loss values exhibited by the machine-learned model for the online training examples as evaluated by a loss function;
identifying a subset of the online training examples as hard examples based at least in part on the respective loss values exhibited by the machine-learned model for the online training examples; and
re-training the machine-learned model using the identified subset of online training examples that are hard examples.

17. The computing system of claim 16, wherein the loss function comprises an unsupervised or weakly supervised loss function.

18. The computing system of claim 16, wherein:
the machine-learned model has been trained to perform the task by training on a task-specific loss function that is specific to the task; and
the loss function comprises a pre-training loss function that is different from the task-specific loss function and not specific to the task.

19. The computing system of claim 18, wherein:
the machine-learned model comprises a language model; and
the pre-training loss function comprises a masked language modeling loss function.

20. The computing system of claim 18, wherein the pre-training loss function comprises a binary cross-entropy loss function that evaluates a click-through-rate of content selected by the machine-learned model.

21. The computing system of claim 16, wherein the machine learned model is an image classification model that takes as input an image and outputs a distribution over one or more image and/or classes.

22. The computing system of claim 16, wherein the operations further comprise:
monitoring the respective loss values exhibited by the machine-learned model for the online training examples to detect when to perform said identifying the subset and said re-training.
